(19) United States
(12) Patent Application Publication
(10) Pub. No.: US 2014/0334280 A1
(43) Pub. Date: Nov. 13, 2014

(54) Systems and Methods for Characterizing Head Contact

(71) Applicant: LSI Corporation, San Jose, CA (US)

(72) Inventor: Xiufeng Song, San Jose, CA (US)

(73) Assignee: LSI Corporation, San Jose, CA (US)

(21) Appl. No.: 14/156,273

(22) Filed: Jan. 15, 2014

Related U.S. Application Data
(60) Provisional application No. 61/822,125, filed on May 10, 2013.
(60) Provisional application No. 61/925,656, filed on Jan. 10, 2014.

(51) Int. Cl. G11B 5/60

(52) U.S. Cl. CPC G11B 5/6076
USPC 369/53.38

(57) ABSTRACT

The present inventions are related to systems and methods for determining contact between two elements, and more particularly to systems and methods for determining contact between a head assembly and a storage medium.

### CROSS REFERENCE TO RELATED APPLICATION

The present application claims priority to U.S. Pat. App. No. 61/822,125 entitled “Systems and Methods for Energy Based Head Contact Detection” and filed on May 10, 2013 by Song et al., and to U.S. Pat. App. No. 61/925,656 entitled “Systems and Methods for Characterizing Head Contact” and filed on Jan. 10, 2014 by Song. The entirety of each of the aforementioned references is incorporated herein by reference for all purposes.

### FIELD OF THE INVENTION

The present inventions are related to systems and methods for characterizing contact between two elements, and more particularly to systems and methods for characterizing contact between a head assembly and a storage medium.

### BACKGROUND

Typical implementations of hard disk based storage devices utilize a thermal element to control the fly height of the read/write head. Heating the thermal element causes a distance between the read/write head and a storage medium to decrease. Where the heat generated by the thermal element is sufficient, the read/write head may be brought into contact with the storage medium. In some cases, this contact can damage one or more components of the storage device.

Hence, for at least the aforementioned reason, there exists a need in the art for advanced systems and methods for determining contact between the read/write head and the storage medium.

### BRIEF SUMMARY

The present inventions are related to systems and methods for characterizing contact between two elements, and more particularly to systems and methods for characterizing contact between a head assembly and a storage medium.

Various embodiments of the present invention provide storage devices that include: a storage medium; a read/write head assembly; a touch down detection circuit; and a head contact characterization circuit. The read/write head assembly is disposed in relation to the storage medium, and includes a sensor operable to provide a sensor output indicating contact between the read/write head assembly and the storage medium. The touch down detection circuit is operable to indicate a contact between the read/write head assembly and the storage medium. The head contact characterization circuit is operable to determine a level of contact between the read/write head assembly and the storage medium. The level of contact is selected between at least a first contact level and a second contact level.

This summary provides only a general outline of some embodiments of the invention. The phrases “in one embodiment,” “according to one embodiment,” in various embodiments“, in one or more embodiments”, in particular embodiments” and the like generally mean the particular feature, structure, or characteristic following the phrase is included in at least one embodiment of the present invention, and may be included in more than one embodiment of the present invention. Importantly, such phases do not necessarily refer to the same embodiment. Many other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 shows a storage system including a read channel circuit having head contact characterization circuitry in accordance with various embodiments of the present invention;

FIG. 2 graphically depicts an example read/write head disposed above the surface of a storage medium that may be used in relation to different embodiments of the present invention;

FIG. 3a shows a data processing circuit including a head contact characterization circuit in accordance with some embodiments of the present invention.

FIG. 3b shows an implementation of an energy based touch down detection circuit that may be used in relation to one or more embodiments of the present invention;

FIG. 3c shows an implementation of a head contact characterization circuit in accordance with some embodiments of the present invention;

FIG. 3d is an example timing diagram showing a process of head contact characterization in accordance with one or more embodiments of the present invention;

FIGS. 4a-4d graphically depict example signal outputs from a head disk interface sensor that vary as a function of the amount of contact between the read/write head assembly and the surface of the storage medium; and

FIGS. 5a-5b are flow diagrams showing a method for contact detection and characterization in accordance with some embodiments of the present invention.

### DETAILED DESCRIPTION OF THE INVENTION

The present inventions are related to systems and methods for characterizing contact between two elements, and more particularly to systems and methods for characterizing contact between a head assembly and a storage medium.

A hard disk interface (“HDI”) sensor is included in the read/write head assembly. As the read/write head assembly flies close to the storage medium, a resonance is generated in the mechanical system including the read/write head assembly. This resonance may be used for touch down detection and in some systems a resonance detector has been employed to detect contact or touch down. However, utilization of such a resonance detector has some drawbacks including a relatively large number of parameters that must be characterized and controlled. As an example, a resonance detector may include four parameters: threshold, windows length, windows interval, and down sampling rate. These parameters are mutually dependent, and contact detection performance depends on all of the parameters. Determination of a contact detection threshold is inexact and therefore difficult to select. Further, use of such resonance detection requires knowledge of an approximate resonance frequency.

Various embodiments of the present invention utilize an energy based approach for contact determination, and a contact characterization algorithm is applied to classify the level of a detected contact. In one particular embodiment of the present invention, characterizing the contact includes indicating one of three distinct levels of contact: slight contact, intermittent contact, and full contact.

Various embodiments of the present invention provide storage devices that include: a storage medium; a read/write head assembly; a touch down detection circuit; and a head contact characterization circuit. The read/write head assembly is disposed in relation to the storage medium, and includes a sensor operable to provide a sensor output indicating contact between the read/write head assembly and the storage medium. The touch down detection circuit is operable to indicate a contact between the read/write head assembly and the storage medium. The head contact characterization circuit is operable to determine a level of contact between the read/write head assembly and the storage medium. The level of contact is selected between at least a first contact level and a second contact level. In some cases, the storage device is a hard disk drive. In some instances of the aforementioned embodiments, the first contact level is a full contact, and the second contact level either a slight contact or an intermittent contact. In various instances of the aforementioned embodiments, the level of contact is selected between at least a first contact level, a second contact level, and a third contact level. In such instances, the first contact level is a full contact, the second contact level is an intermittent contact, and the third contact level is a slight contact.

In various instance of the aforementioned embodiments, the head contact characterization circuit is further operable to provide a contact level output indicating the level of contact only if the touch down detection circuit indicates the contact between the read/write head assembly and the storage medium. In one or more instances of the aforementioned embodiments, the contact characterization circuit includes: a signal processing circuit operable to generate a contact indicative signal from the sensor output; a crossing counter operable to count a number of times the contact indicative signal crosses a threshold value to yield a count value; and a contact classification circuit operable to select the level of contact between the read/write head assembly and the storage medium based at least in part on the count value. In some such instances, the contact classification circuit includes a comparator circuit operable to compare the count value with a level threshold value to distinguish between the first contact level and the second contact level. In some cases, the aforementioned level threshold is user programmable. In various cases, the aforementioned threshold value is zero. In one or more cases, the level of contact is selected between at least a first contact level, a second contact level, and a third contact level. The first contact level is a full contact, the second contact level is an intermittent contact, and the third contact level is a slight contact. In such cases, the contact classification circuit includes a first comparator circuit operable to compare the count value with a first level threshold value and a second comparator circuit operable to compare the count value with a second level threshold value to distinguish between the first contact level, the second contact level, and the third contact level. In one or more cases, the signal processing circuit includes a signal averaging circuit operable to average multiple instances to yield a series of average instances, and a tripartite grouping circuit operable to assign one of three values to each of element of the series of instances to yield the contact indicative signal.

Other embodiments of the present invention provide methods for contact classification. The methods include: receiving a head contact indication and a sensor output; processing the sensor input to determine a number of threshold crossings using a crossing counter circuit; and selecting a contact level from at least a first contact level and a second contact level based at least in part on a combination of the head contact indication and the number of threshold crossings. In some cases, the first contact level is a full contact, and the second contact level is either a slight contact or an intermittent contact. In other cases, the level of contact is selected between at least a first contact level, a second contact level, and a third contact level. In such cases, the first contact level is a full contact, the second contact level is an intermittent contact, and the third contact level is a slight contact. The methods may further include: processing the sensor signal to generate a contact indicative signal from the sensor output; and counting a number of times the contact indicative signal crosses a threshold value to yield the number of threshold crossings.

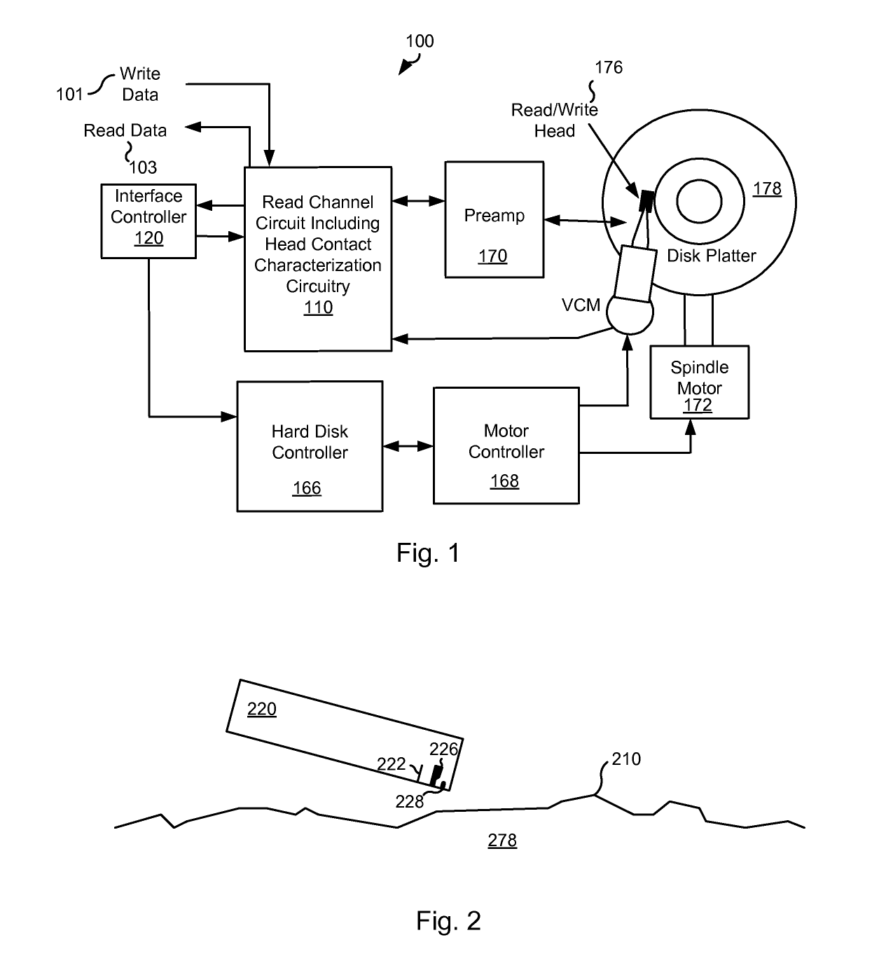

Turning to FIG. 1, a storage system 100 including a read channel circuit 110 having head contact characterization circuitry is shown in accordance with various embodiments of the present invention. Storage system 100 may be, for example, a hard disk drive. Storage system 100 also includes a preamplifier 170, an interface controller 120, a hard disk controller 166, a motor controller 168, a spindle motor 172, a disk platter 178, and a read/write head 176. Interface controller 120 controls addressing and timing of data to/from disk platter 178. The data on disk platter 178 consists of groups of magnetic signals that may be detected by read/write head assembly 176 when the assembly is properly positioned over disk platter 178. In one embodiment, disk platter 178 includes magnetic signals recorded in accordance with either a longitudinal or a perpendicular recording scheme.

In a typical read operation, read/write head assembly 176 is accurately positioned by motor controller 168 over a desired data track on disk platter 178. Motor controller 168 both positions read/write head assembly 176 in relation to disk platter 178 and drives spindle motor 172 by moving read/write head assembly to the proper data track on disk platter 178 under the direction of hard disk controller 166. Spindle motor 172 spins disk platter 178 at a determined spin rate (RPMs). Once read/write head assembly 176 is positioned adjacent the proper data track, magnetic signals representing data on disk platter 178 are sensed by read/write head assembly 176 as disk platter 178 is rotated by spindle motor 172. The sensed magnetic signals are provided as a continuous, minute analog signal representative of the magnetic data on disk platter 178. This minute analog signal is transferred from read/write head assembly 176 to read channel circuit 110 via preamplifier 170. Preamplifier 170 is operable to amplify the minute analog signals accessed from disk platter 178. In turn, read channel circuit 110 decodes and digitizes the received analog signal to recreate the information originally written to disk platter 178. This data is provided as read data 103 to a receiving circuit. A write operation is substantially the opposite of the preceding read operation with write data 101 being provided to read channel circuit 110. This data is then encoded and written to disk platter 178.

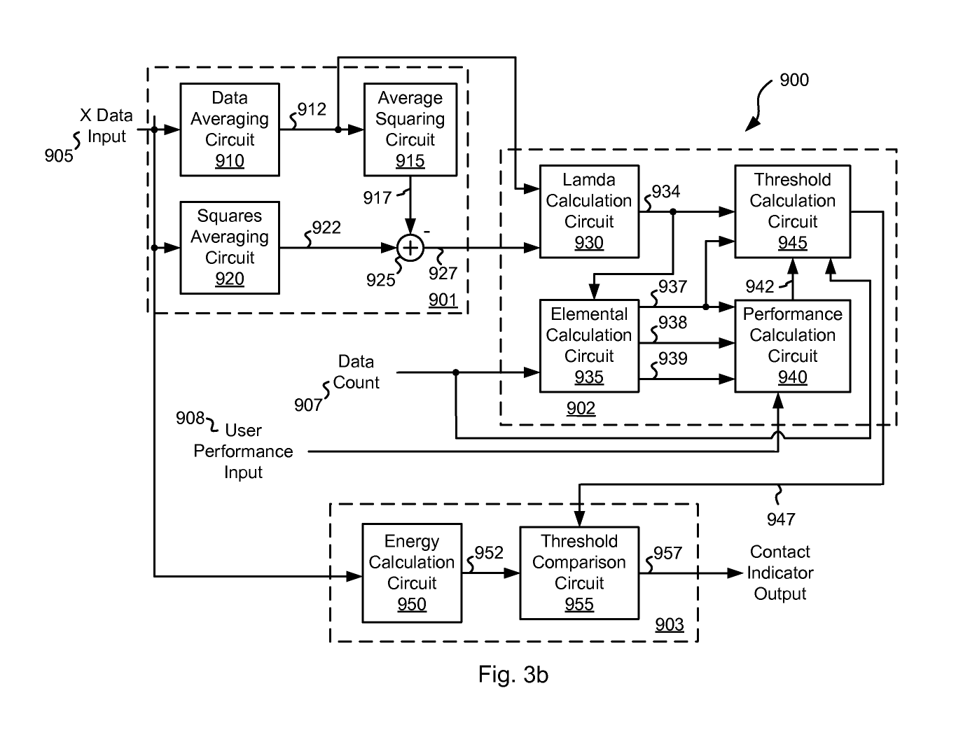

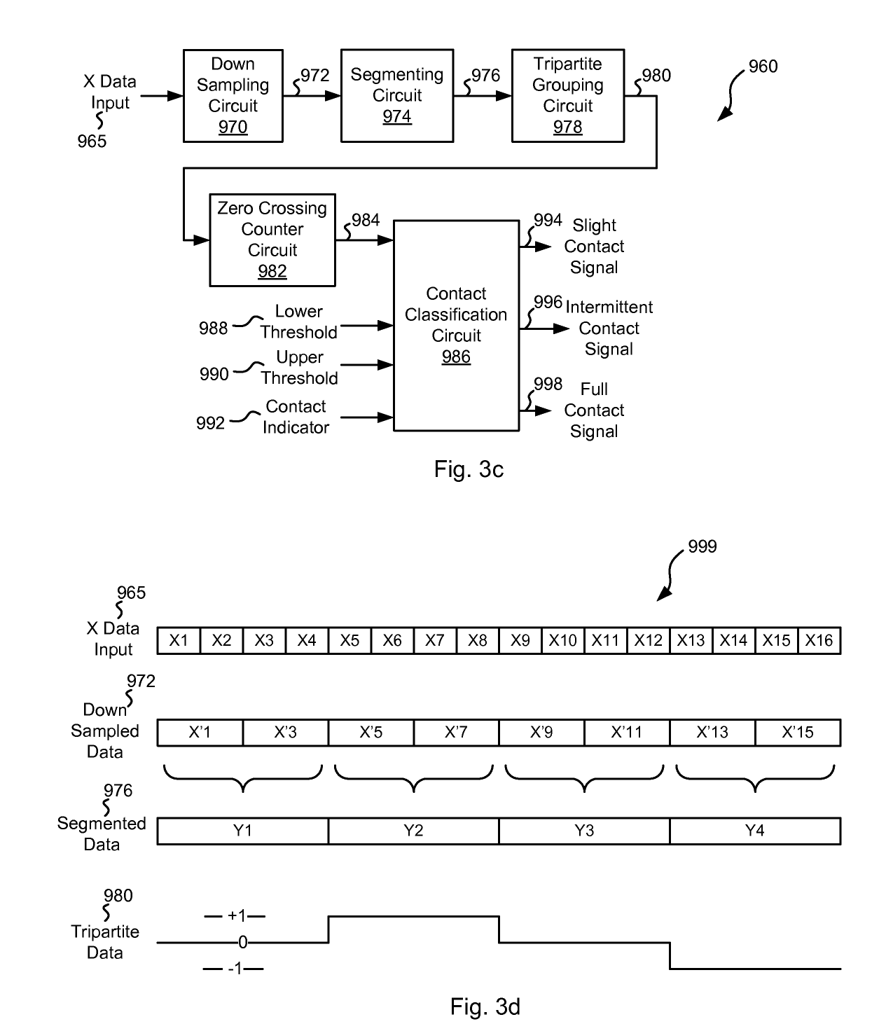

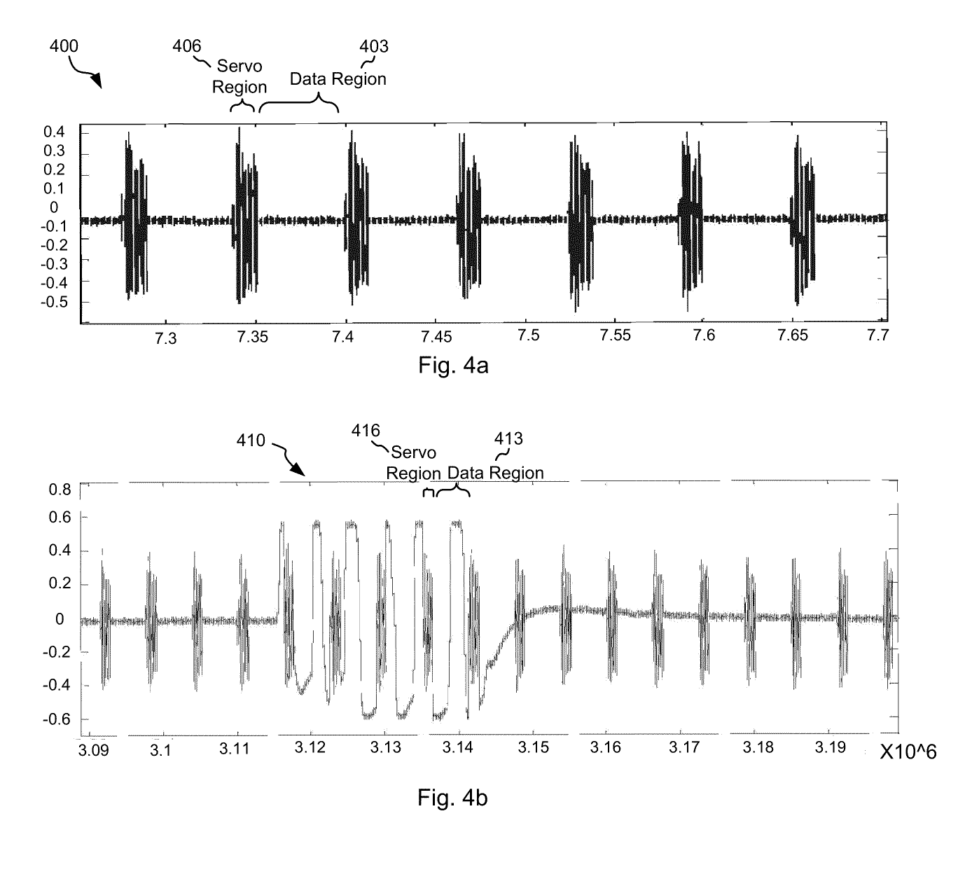

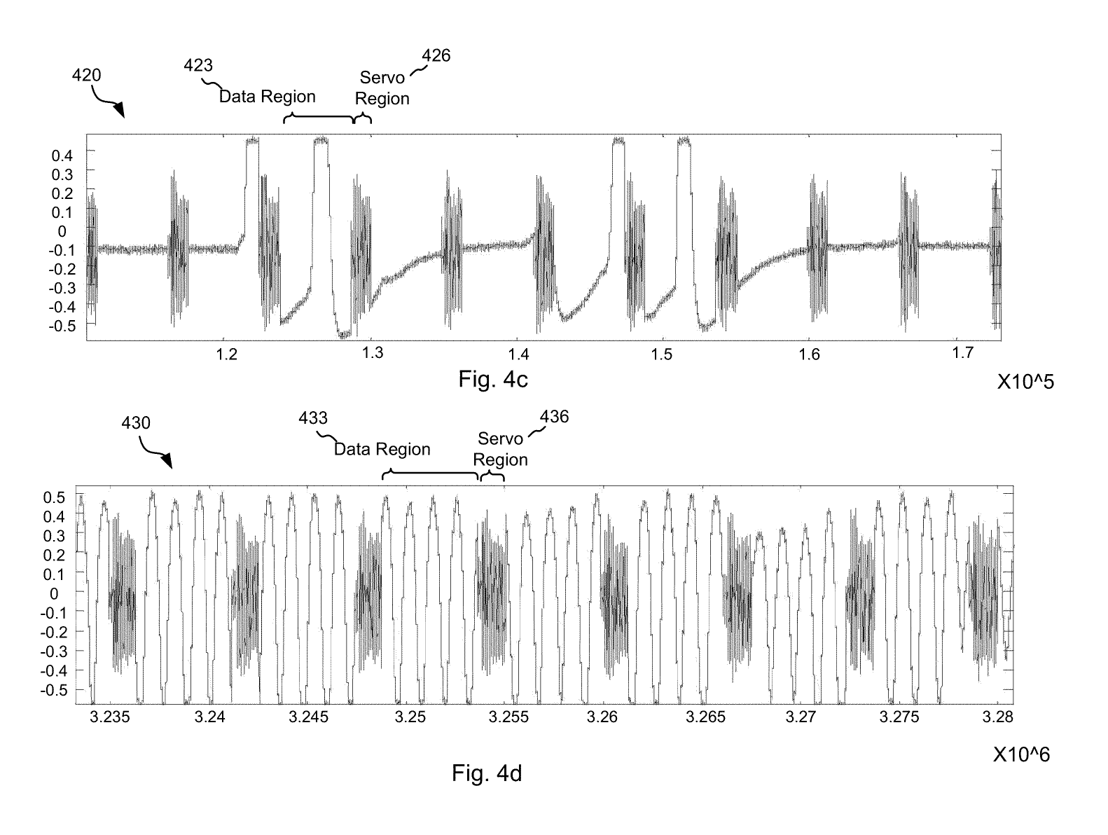

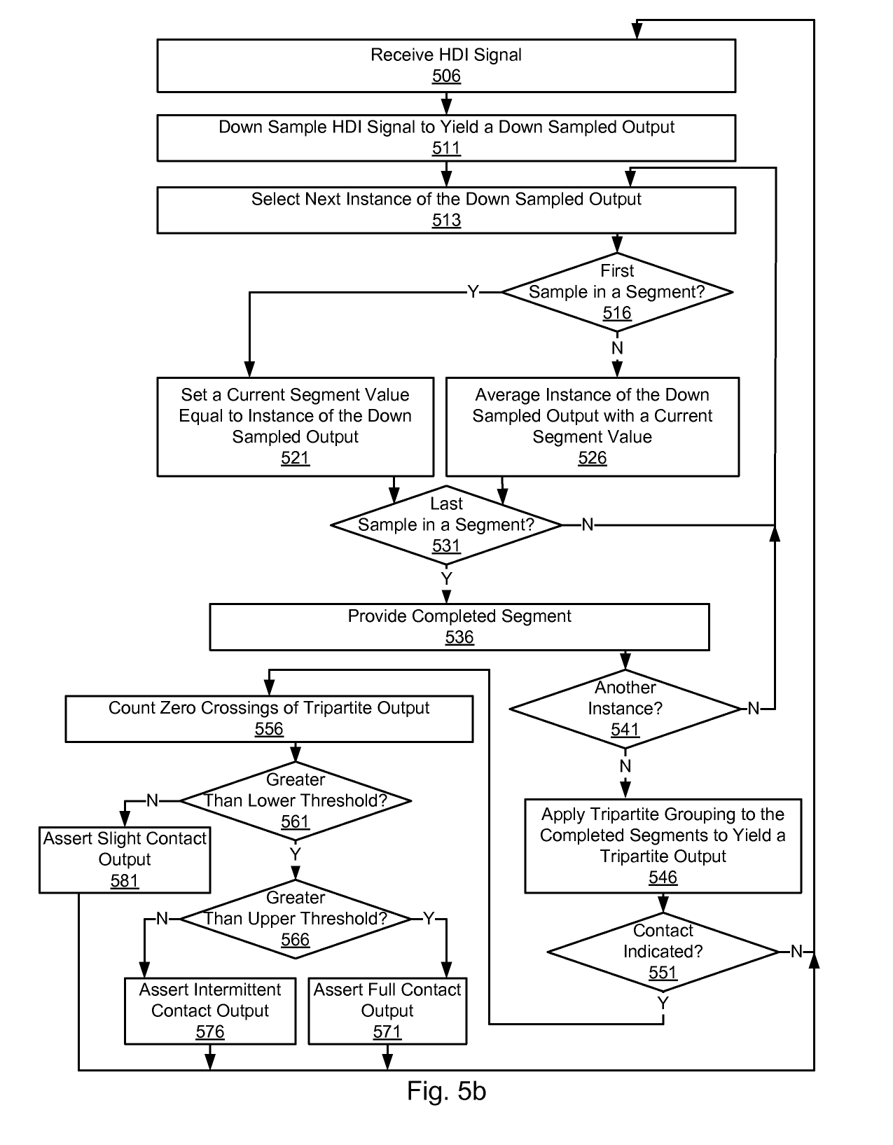

In addition to sensing data stored on disk platter 178, read/write head assembly 176 provides for sensing contact between read/write head assembly 176 and disk platter 178. In some cases, such sensing includes determining an energy level derived from a touch sensor, and using the energy level to determine whether the read/write head assembly 176 is contacting disk platter. Based upon the disclosure provided herein, one of ordinary skill in the art will recognize other approaches for sensing contact that may be used in relation to various embodiments of the present invention. A contact characterization algorithm is applied to classify the level of contact detected. In one particular embodiment of the present invention, characterizing the contact includes indicating one of three distinct levels of contact: slight contact, intermittent contact, and full contact. In some cases, read channel circuit 110 is implemented similar to that disclosed in relation to FIG. 3a below, and the contact characterization circuitry may be implemented similar to that disclosed below in relation to FIG. 3c. Further, the systems may operate consistent with that discussed below in relation to FIGS. 5a-5b.

It should be noted that storage system 100 may be integrated into a larger storage system such as, for example, a RAID (redundant array of inexpensive disks or redundant array of independent disks) based storage system. Such a RAID storage system increases stability and reliability through redundancy, combining multiple disks as a logical unit. Data may be spread across a number of disks included in the RAID storage system according to a variety of algorithms and accessed by an operating system as if it were a single disk. For example, data may be mirrored to multiple disks in the RAID storage system, or may be sliced and distributed across multiple disks in a number of techniques. If a small number of disks in the RAID storage system fail or become unavailable, error correction techniques may be used to recreate the missing data based on the remaining portions of the data from the other disks in the RAID storage system. The disks in the RAID storage system may be, but are not limited to, individual storage systems such as storage system 100, and may be located in close proximity to each other or distributed more widely for increased security. In a write operation, write data is provided to a controller, which stores the write data across the disks, for example by mirroring or by striping the write data. In a read operation, the controller retrieves the data from the disks. The controller then yields the resulting read data as if the RAID storage system were a single disk.

A data decoder circuit used in relation to read channel circuit 110 may be, but is not limited to, a low density parity check (LDPC) decoder circuit as are known in the art. Such low density parity check technology is applicable to transmission of information over virtually any channel or storage of information on virtually any media. Transmission applications include, but are not limited to, optical fiber, radio frequency channels, wired or wireless local area networks, digital subscriber line technologies, wireless cellular, Ethernet over any medium such as copper or optical fiber, cable channels such as cable television, and Earth-satellite communications. Storage applications include, but are not limited to, hard disk drives, compact disks, digital video disks, magnetic tapes and memory devices such as DRAM, NAND flash, NOR flash, other non-volatile memories and solid state drives.

In addition, it should be noted that storage system 100 may be modified to include solid state memory that is used to store data in addition to the storage offered by disk platter 178. This solid state memory may be used in parallel to disk platter 178 to provide additional storage. In such a case, the solid state memory receives and provides information directly to read channel circuit 110. Alternatively, the solid state memory may be used as a cache where it offers faster access time than that offered by disk platted 178. In such a case, the solid state memory may be disposed between interface controller 120 and read channel circuit 110 where it operates as a pass through to disk platter 178 when requested data is not available in the solid state memory or when the solid state memory does not have sufficient storage to hold a newly written data set. Based upon the disclosure provided herein, one of ordinary skill in the art will recognize a variety of storage systems including both disk platter 178 and a solid state memory.

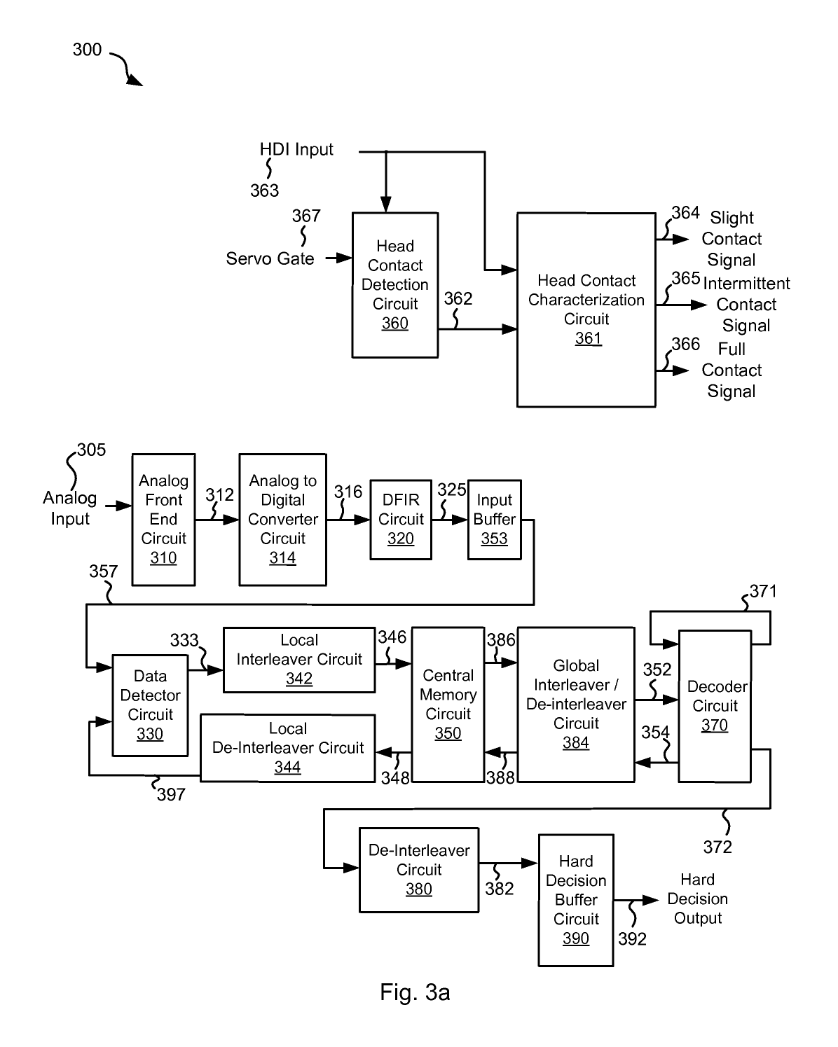

Turning to FIG. 2, a graphical depiction of an example read/write head assembly 220 disposed above a surface 210 of a storage medium 278 that may be used in relation to different embodiments of the present invention. As shown, read write head assembly 220 includes a heater element 222 that is operable to control a distance between read write head assembly 220 and surface 210, a read/write head 226 operable to generate magnetic fields to store information on surface 210 and to sense magnetic information previously stored on surface 210, and a head disk interface sensor 228 operable to sense contact between read/write head assembly 220 and surface 210.

Turning to FIG. 3a, a data processing circuit 300 is shown that includes a head contact characterization circuit 361 in accordance with some embodiments of the present invention. Data processing circuit 300 includes an analog front end circuit 310 that receives an analog signal 305. Analog front end circuit 310 processes analog signal 305 and provides a processed analog signal 312 to an analog to digital converter circuit 314. Analog front end circuit 310 may include, but is not limited to, an analog filter and an amplifier circuit as are known in the art. Based upon the disclosure provided herein, one of ordinary skill in the art will recognize a variety of circuitry that may be included as part of analog front end circuit 310. In some cases, analog signal 305 is derived from a read/write head assembly (not shown) that is disposed in relation to a storage medium (not shown). In other cases, analog signal 305 is derived from a receiver circuit (not shown) that is operable to receive a signal from a transmission medium (not shown). The transmission medium may be wired or wireless. Based upon the disclosure provided herein, one of ordinary skill in the art will recognize a variety of source from which analog input 305 may be derived.

Analog to digital converter circuit 314 converts processed analog signal 312 into a corresponding series of digital samples 316. Analog to digital converter circuit 314 may be any circuit known in the art that is capable of producing digital samples corresponding to an analog input signal. Based upon the disclosure provided herein, one of ordinary skill in the art will recognize a variety of analog to digital converter circuits that may be used in relation to different embodiments of the present invention. Digital samples 316 are provided to an equalizer circuit 320. Equalizer circuit 320 applies an equalization algorithm to digital samples 316 to yield an equalized output 325. In some embodiments of the present invention, equalizer circuit 320 is a digital finite impulse response filter circuit as are known in the art. It may be possible that equalized output 325 may be received directly from a storage device in, for example, a solid state storage system. In such cases, analog front end circuit 310, analog to digital converter circuit 314 and equalizer circuit 320 may be eliminated where the data is received as a digital data input. Equalized output 325 is stored to an input buffer 353 that includes sufficient memory to maintain a number of codewords until processing of that codeword is completed through a data detector circuit 330 and decoder circuit 370 including, where warranted, multiple global iterations (passes through both data detector circuit 330 and decoder circuit 370) and/or local iterations (passes through decoder circuit 370 during a given global iteration). An output 357 is provided to data detector circuit 330.

Data detector circuit 330 may be a single data detector circuit or may be two or more data detector circuits operating in parallel on different codewords. Whether it is a single data detector circuit or a number of data detector circuits operating in parallel, data detector circuit 330 is operable to apply a data detection algorithm to a received codeword or data set. In some embodiments of the present invention, data detector circuit 330 is a Viterbi algorithm data detector circuit as are known in the art. In other embodiments of the present invention, data detector circuit 330 is a maximum a posteriori data detector circuit as are known in the art. Of note, the general phrases “Viterbi data detection algorithm” or “Viterbi algorithm data detector circuit” are used in their broadest sense to mean any Viterbi detection algorithm or Viterbi algorithm detector circuit or variations thereof including, but not limited to, bi-direction Viterbi detection algorithm or bi-direction Viterbi algorithm detector circuit. Also, the general phrases “maximum a posteriori data detection algorithm” or “maximum a posteriori data detector circuit” are used in their broadest sense to mean any maximum a posteriori detection algorithm or detector circuit or variations thereof including, but not limited to, simplified maximum a posteriori data detection algorithm and a max-log maximum a posteriori data detection algorithm, or corresponding detector circuits. Based upon the disclosure provided herein, one of ordinary skill in the art will recognize a variety of data detector circuits that may be used in relation to different embodiments of the present invention. In some cases, one data detector circuit included in data detector circuit 330 is used to apply the data detection algorithm to the received codeword for a first global iteration applied to the received codeword, and another data detector circuit included in data detector circuit 330 is operable apply the data detection algorithm to the received codeword guided by a decoded output accessed from a central memory circuit 350 on subsequent global iterations.

Upon completion of application of the data detection algorithm to the received codeword on the first global iteration, data detector circuit 330 provides a detector output 333. Detector output 333 includes soft data. As used herein, the phrase “soft data” is used in its broadest sense to mean reliability data with each instance of the reliability data indicating a likelihood that a corresponding bit position or group of bit positions has been correctly detected. In some embodiments of the present invention, the soft data or reliability data is log likelihood ratio data as is known in the art. Detector output 333 is provided to a local interleaver circuit 342. Local interleaver circuit 342 is operable to shuffle sub-portions (i.e., local chunks) of the data set included as detected output and provides an interleaved codeword 346 that is stored to central memory circuit 350. Interleaver circuit 342 may be any circuit known in the art that is capable of shuffling data sets to yield a re-arranged data set. Interleaved codeword 346 is stored to central memory circuit 350.

Once decoder circuit 370 is available, a previously stored interleaved codeword 346 is accessed from central memory circuit 350 as a stored codeword 386 and globally interleaved by a global interleaver/de-interleaver circuit 384. Global interleaver/de-interleaver circuit 384 may be any circuit known in the art that is capable of globally rearranging codewords. Global interleaver/De-interleaver circuit 384 provides a decoder input 352 into decoder circuit 370. In some embodiments of the present invention, the data decode algorithm is a layered low density parity check algorithm as are known in the art. In other embodiments of the present invention, the data decode algorithm is a non-layered low density parity check algorithm as are known in the art.

Where decoded output 371 fails to converge (i.e., fails to yield the originally written data set) and a number of local iterations through decoder circuit 370 exceeds a threshold, the resulting decoded output is provided as a decoded output 354 back to central memory circuit 350 where it is stored awaiting another global iteration through a data detector circuit included in data detector circuit 330. Prior to storage of decoded output 354 to central memory circuit 350, decoded output 354 is globally de-interleaved to yield a globally de-interleaved output 388 that is stored to central memory circuit 350. The global de-interleaving reverses the global interleaving earlier applied to stored codeword 386 to yield decoder input 352. When a data detector circuit included in data detector circuit 330 becomes available, a previously stored de-interleaved output 388 is accessed from central memory circuit 350 and locally de-interleaved by a de-interleaver circuit 344. De-interleaver circuit 344 re-arranges decoder output 348 to reverse the shuffling originally performed by interleaver circuit 342. A resulting de-interleaved output 397 is provided to data detector circuit 330 where it is used to guide subsequent detection of a corresponding data set previously received as equalized output 325.

Alternatively, where the decoded output converges (i.e., yields the originally written data set), the resulting decoded output is provided as an output codeword 372 to a de-interleaver circuit 380 that rearranges the data to reverse both the global and local interleaving applied to the data to yield a de-interleaved output 382. De-interleaved output 382 is provided to a hard decision buffer circuit 390 that arranges the received codeword along with other previously received codewords in an order expected by a requesting host processor. The resulting output is provided as a hard decision output 392.

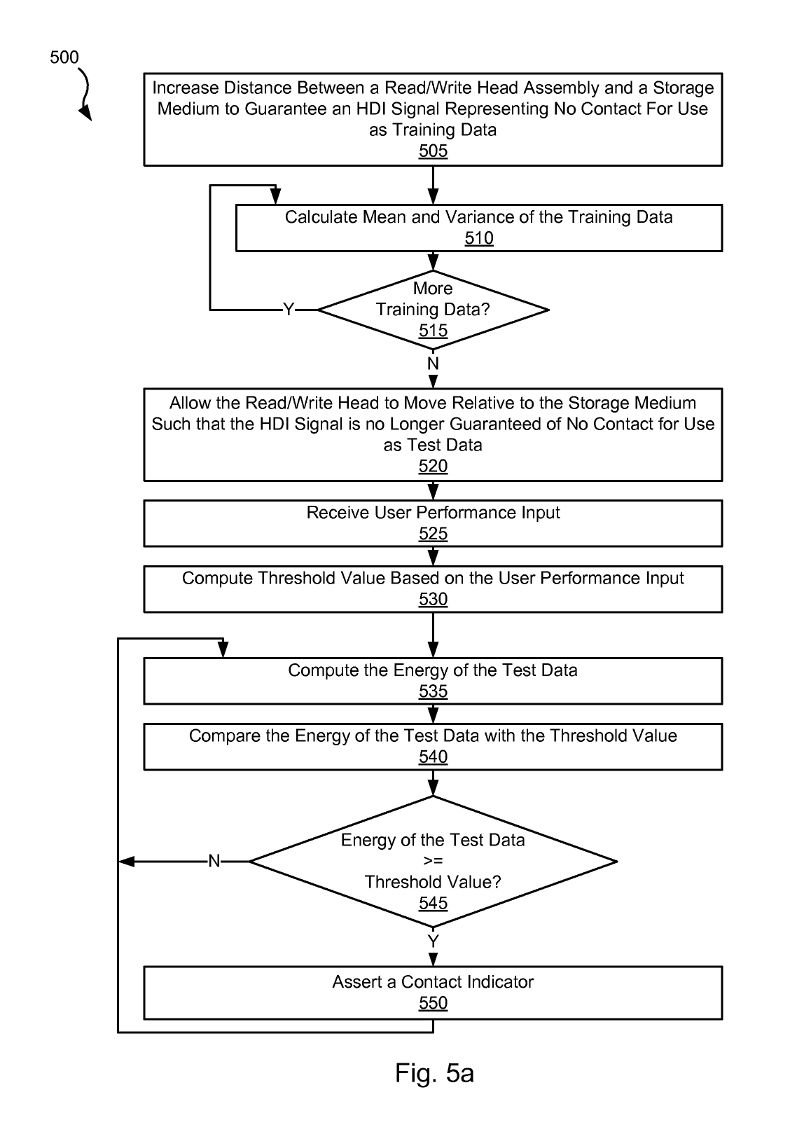

Decoder circuit 370 is designed to accept codewords that are not constrained by a ‘1’ symbol in the final circulant in the codeword. This is facilitated by using a standard non-binary, low density parity check decoder circuit that is augmented to include an inverse mapping circuit to adjust a soft data output to compensate for the non-constrained circulant. Such an approach utilizes only a relatively small amount of additional circuitry, but results in an increased distance between possible accepted decoded outputs thereby reducing the likelihood of a mis-correction. One example implementation of decoder circuit 370 is described below in relation to FIG. 4 below.

In addition, data processing circuit 300 includes a head contact detection circuit 360 that is operable to assert a touch down signal 362 when contact between a read/write head assembly and a storage medium is sensed. Head contact detection circuit 360 receives a head/disk interface (“HDI”) input 363 that represents a temperature of a read/write head assembly. When a read/write head assembly contacts a storage medium, there is a dramatic increase in temperature of the read/write head assembly that causes a corresponding dramatic change in HDI input 363.

Turning to FIGS. 4a-4d, HDI input corresponding to four different contact scenarios are shown. First, in FIG. 4a, a normal or non-contact scenario is shown including a servo region 406 and a data region 403. The HDI input during data region 403 is used to determine contact, and as the HDI input exhibits only a small magnitude, no zero crossings (as further discussed below) occur which is consistent with a no-contact situation. As shown, the amplitude of the HDI input during data region 403 is relatively low and substantially constant. Second, in FIG. 4b, an intermittent contact scenario is shown including a servo region 416 and a data region 413. As shown, during data region 413 the magnitude of the HDI input becomes significant a number of times over a window of time resulting in a number of zero crossings over the window of time consistent with an intermittent contact. Third, in FIG. 4c, a slight contact scenario is shown including a servo region 426 and a data region 423. In the slight contact scenario, there is a significant increase in the energy of the HDI input similar to the previously described intermittent contact scenario, however, the number of zero crossings during the same window is less. This reduced frequency of zero crossings is consistent with a slight contact scenario. Fourth, in FIG. 4d, a full contact scenario is shown including a servo region 436 and a data region 433. As with the slight contact scenario and the intermittent contact scenario, there is a significant increase in the energy of the HDI input. Unlike the slight contact scenario and the intermittent contact scenario the frequency of the zero crossings of the HDI input is higher consistent with a full contact scenario.

Returning again to FIG. 3a, head contact detection circuit 360 may be implemented, for example, as an energy based touch down detection circuit that calculates an energy of the HDI input 363 during a data region. The data region is indicated when a servo gate 367 is asserted low. In addition, the energy based touch down detection circuit calculates an energy threshold to which the energy of HDI input 363 is compared. Where the energy of HDI input 363 is greater than the calculated energy threshold, touch down signal 362 is asserted indicating contact between the read/write head assembly and the storage medium. Otherwise, where HDI input 363 is less than the calculated energy threshold, touch down signal 362 is not asserted. Based upon the disclosure provided herein, one of ordinary skill in the art will recognize other types of head contact detection circuits that may be used in relation to different embodiments of the present invention.

Turning to FIG. 3b, one implementation of an energy based touch down detection circuit that may be used in place of head contact detection circuit 360 of FIG. 3a is shown. An energy based touch down detection circuit 900 is shown that includes a parameter training circuit 901 that is operable to calculate a mean (μ) and variance (σ²) of an X-data input 905, a threshold determination circuit 902 that is operable to calculate an energy threshold indicative of contact between a read/write head assembly and a storage medium, and a touch down detection circuit 903 operable to indicate touch down based upon comparison with the energy threshold.

Training data is X-data input 905 from the HDI sensor which is generated at a time when the read/write head assembly is disposed a distance from the storage medium that guarantees that no contact occurs. Parameter training is performed by parameter training circuit 901 using X-data input 905. Using test data, the signal from the HDI sensor is zero or very small (e.g., FIG. 4a). Using this condition, the training data (X-data input 905) can be represented as:

x=[x₁,x₂,x₃, . . . x_{N}]².

From this, the likelihood function of the mean and variance of X-data input 905 may be written as:

$$f ( x \vert μ , {σ}^{2} ) = {\prod }_{i = 1}^{N} \frac{1}{\sqrt{2 {πσ}^{2}}} {e}^{- ( \frac{X - data Input 905}{2 {σ}^{2}} )} .$$

Thus, the maximum likelihood estimate of mean μ and variance σ² can be obtained via the following equations:

$$\{ \hat{μ} , {\hat{σ}}^{2} \} = arg {max}_{μ , {σ}^{2}} f ( x \vert μ , {σ}^{2} ) , \\ and$$

$$\{ \hat{μ} , {\hat{σ}}^{2} \} = arg {max}_{μ , {σ}^{2}} \underbrace{log f ( x \vert μ , {σ}^{2} )}_{\hat{=} g ( μ , {σ}^{2} )} .$$

Form this, the following equations are solved:

$$\frac{\partial ( μ , {σ}^{2} )}{\partial μ} = 0 , \\ and$$

$$\frac{\partial ( μ , {σ}^{2} )}{\partial {σ}^{2}} = 0.$$

The solution yields the final equations for the mean and the variance:

$$μ = \frac{1}{N} {\sum }_{i = 1}^{N} X - Data Input 905 , \\ and$$

$${σ}^{2} = \frac{1}{N} {\sum }_{i = 1}^{N} {( X - Data Input 905 )}^{2} - {μ}^{2} .$$

Using the aforementioned equations for mean and variance, parameter training circuit 901 includes a data averaging circuit 910, a squares averaging circuit 920, an average squaring circuit 915, and a summation circuit 925. Data averaging circuit 910 calculates a mean (μ 912) of X-data input 905 in accordance with the following equation:

$$μ 912 = \frac{1}{N} {\sum }_{i = 1}^{N} X - Data Input 905.$$

Mean 912 is provided to average squaring circuit 915 where it is squared to yield a squared output (μ² 917). Squares averaging circuit 920 calculates an average of squared X-data input 905 (r 922) in accordance with the following equation:

$$r 922 = \frac{1}{N} {\sum }_{i = 1}^{N} {( X - Data Input 905 )}^{2} .$$

Summation circuit subtracts μ² 917 from r 922 to yield a variance 927 (σ² 927).

Variance 927 and mean 912 are provided to threshold determination circuit 902. Threshold determination circuit 902 performs threshold determination using variance 927 and mean 912 from parameter training circuit 901, a data count 907, and a user performance input 908. Test data is X-data input 905 from the HDI sensor which is generated at a time when the read/write head assembly is not guaranteed not to be contacting the storage medium. Threshold calculation is performed by threshold determination circuit 902 using X-data input 905. The test data (X-data input 905) can be represented as:

y=[y₁,y₂,y₃, . . . y_{N}]^{M}.

Where such is the case, an energy detector may be mathematically recast as:

$${y}^{T} y = {\sum }_{i = 1}^{M} {y}_{i}^{2} {>}^{{H}_{1}} {<}_{{H}_{0}} T ,$$

where T is the threshold value, H₁ is the touch down condition, and H₀ is the normal, non-touch down condition. By defining

$${z}_{i} = \frac{{y}_{i}}{σ}$$

$$and$$

$${T}_{1} = \frac{T}{{σ}^{2}} ,$$

then the preceding equation can be re-written as:

$$h ( z ) = {\sum }_{i = 1}^{M} {z}_{i}^{2} {>}^{{H}_{1}} {<}_{{H}_{0}} {T}_{1} .$$

Since yᵢ follows the Gaussian distribution with mean μ and variance σ² under the null hypothesis H₀, Zᵢ is Gaussian random variable with unit variance and mean μ. As a result, the test statistics h(z) will follow the non-central chi-squared distribution.

A false alarm occurs when a touch down condition is indicated without contact between the read/write head assembly and the storage medium. As such, a false alarm may be mathematically represented as:

{h(z)|H₀>T₁}.

Using this, the probability (P_{f}) of the false alarm rate may be mathematically represented as follows:

$${P}_{f} = {e}^{- \frac{λ}{2}} {\sum }_{j = 1}^{∞} \frac{{( λ \text{/} 2 )}^{j}}{j !} Q ( {T}_{i} , M + 2 j ) ,$$

where Q(Tᵢ,k) is the cumulative distribution function of the central chi-squared distribution with k degrees of freedom, and λ=(μ/σ²)². The user provides the probability (P_{f}) as user performance input 908. This user provided probability may be approximated as:

$${P}_{f} = Φ ( \frac{{( \frac{{T}_{1}}{M + λ} )}^{h} - [ 1 + hp ( h - 1 - 0.5 ( 2 - h ) mp ) ]}{h \sqrt{2 p} ( 1 + 0.5 mp )} ) ,$$

where Φ is the cumulative distribution function of the standard normal distribution,

$$h = 1 - \frac{2}{3} \frac{( M + λ ) ( M + 2 λ )}{{( M + 2 λ )}^{2}} , \\ p = \frac{( M + 2 λ )}{{( M + λ )}^{2}} , \\ and$$

$$m = ( h - 1 ) ( 1 - 3 h ) .$$

Of note, each of h, p and m do not depend upon threshold T₁, and they can be precalculated for a given data length of the test data. By expressing the function of probability (f(P_{f})) as:

f(P_{f})=h\sqrt{2p}(1+0.5mp)Φ−1(Pf)+[1+hp(h−1−0.5(2−h)mp],

the threshold can be mathematically recast as:

$${T}_{1} = \sqrt[h]{f ( {P}_{f} )} ( M + λ ) .$$

Thus, the threshold is calculated based upon user performance input 908.

Threshold determination circuit 902 includes a lambda calculation circuit 930, an elemental calculation circuit 935, a threshold calculation circuit 945, and a performance calculation circuit 940. Lamda calculation circuit 930 computes the value of λ based upon the product of variance 927 and mean 912 (μσ²). In particular, the value of λ is calculated in accordance with the following equation:

λ=M(μ/σ²)².

where M is the data count 907 (i.e., the number of values used in calculating variance 927 and mean 912), μ is the mean, and σ² is the variance. The calculated value is provided as a lambda output 934 to threshold calculation circuit 945 and elemental calculation circuit 935.

Elemental calculation circuit 935 calculates the values of h, p and m based upon lambda output 934 in accordance with the following equations:

$$h 937 = 1 - \frac{2}{3} \frac{( M + λ 934 ) ( M + 2 ( λ 934 ) )}{{( M + 2 ( λ 934 ) )}^{2}} , \\ p 938 = \frac{( M + 2 ( λ 934 ) )}{{( M + ( λ 934 ) )}^{2}} , \\ and$$

$$m 939 = ( ( h 937 ) - 1 ) ( 1 - 3 ( h 937 ) ) .$$

M is the data count 907 (i.e., the number of values used in calculating variance 927 and mean 912). h 937, p 938 and m 939 are provided to performance calculation circuit 940.

Performance calculation circuit 940 calculates f (P_{f}) based upon user performance input 908, h 937, p 938 and m 939 in accordance with the following equation:

f(P_{f})=(h937)\sqrt{2(p938)}(1+0.5(m939)(p938))Φ⁻¹(Pf)+[1+(h937)(p938)[(h937)−1−0.5(2−(h937)](m939)(p938)]

The calculated value is provided as a performance output 942.

Threshold calculation circuit 945 calculates a threshold output 947 based upon performance output 942 and lambda output 934 in accordance with the following equation:

$$Threshold Output 947 = \sqrt[h]{performance output 942} ( data count 907 + Lambda 934 ) .$$

Threshold output 947 is provided to touch down detection circuit 903.

Touch down detection circuit 903 includes an energy calculation circuit 950 and a threshold comparison circuit 955. Energy calculation circuit 950 calculates an energy in X-data input 905 to yield an energy output 952 (h(z)) in accordance with the following equation:

$$Energy Output 952 = {\sum }_{i = 1}^{M} {( X - Data Input 905 )}^{2} .$$

Energy output 952 is provided to threshold comparison circuit 955 where it is compared with threshold output 947. Where energy output 952 is greater than or equal to threshold output 947, threshold comparison circuit 947 asserts a contact indicator output 957 to indicate a touch down occurred.

Referring again to FIG. 3a, head contact characterization circuit 361 receives touch down signal 362 from head contact detection circuit 360 and HDI input 363. Head contact characterization circuit 361 applies a contact characterization algorithm to HDI input 363 to yield an interim contact level, and when touch down signal 362 is asserted, head contact characterization circuit 361 provides the interim contact level as one of three possible contact levels by asserting a respective one of a slight contact signal 364, an intermittent contact signal 365, and a full contact signal 366. The levels of contact indicated are intended to differentiate between the different types of contact discussed above in relation to FIGS. 4a-4d.

Turning to FIG. 3c, an implementation of head contact characterization circuit 361 is shown as a head contact characterization circuit 960. A shown, head contact characterization circuit 960 includes a down sampling circuit 970 that is operable to down sample an X data input 965 (i.e., XDI Input 363) to yield down sampled data 972. Where the sampling rate at which X data input 965 is sampled is substantially greater than the vibration frequency of a head caused by contact, X Data Input 965 can be down sampled to improve the processing efficiency without degrading classification performance. The amount of down sampling applied may be chosen based upon a combination of the sampling frequency of X data input 965 and the frequency of data represented by X data input 965 (e.g., the frequency of head vibration due to contact).

Down sampled data 972 is provided to a segmenting circuit 974 that combines multiple instances of down sampled data 972 within a given segment to yield a single segment value. In some cases, all instances of down sampled data within a segment window are averaged or summed together to yield the single segment value. Such a process reduces the effect of a single large noise contamination in down sampled data 972. In one particular embodiment, each segment value is derived from four instances of down sampled data 972. Based upon the disclosure provided herein, one of ordinary skill in the art will recognize a variety of numbers of instances of down sampled data to be included in segment values in accordance with different embodiments. In some embodiments, the number of instances of down sampled data 972 included in each segment is user programmable. Segmenting circuit 974 provides the segment values as segmented data 976.

A tripartite grouping circuit 978 assigns one of three distinct values to each segment value of segment data 976. In particular, where the value of a given segment is greater than a threshold A, then a positive value is assigned to the segment. Where, on the other hand, the value of a given segment is less than a threshold B, then a negative value is assigned to the segment. In all other cases, a zero value is assigned to the segment. In one particular case, threshold B is a negative of threshold A. In various cases, one or both of threshold A and threshold B are user programmable. The following pseudocode describes the aforementioned tripartite process.

```
For Each Segment of Segmented Data 976 {
  Select Segment of Segmented Data 976;
  If (Value of Selected Segment is > A) {
    Set Tripartite Value Equal to +1
  }
  Else If (Value of Selected Segment is < −A) {
    Set Tripartite Value Equal to −1
  }
  Else {
    Set Tripartite Value Equal to 0
  }
}
```

The resulting tripartite values for each segment of segment data 976 are provides as tripartite data 980.

Tripartite data 980 is provided to a zero crossing counter circuit 982 that counts the number of times tripartite data transitions from a positive value to a negative value, and from a negative value to a positive value (i.e., each time it crosses the zero point). End points are also accounted for by incrementing the count maintained by zero crossing counter circuit 982 when the count period begins with a zero and subsequently is changed to a positive value or a negative value, and when the count period ends with a zero value from either a positive value or a negative value that occurred within the count period. This process of counting zero crossings is continued over a count period which is a window of time over which zero crossings are monitored. At the end of the count period, zero crossing counter circuit 982 provides the resulting count as a count value 984.

Count value 984 is provided to a contact classification circuit 986 that compares it with a lower threshold 988 and an upper threshold 990. One or both of lower threshold 988 and upper threshold 990 may be user programmable. In particular, where count value 984 is less than lower threshold 988 and a contact indicator 992 (i.e., touch down signal 362) is asserted, contact classification circuit 986 asserts a slight contact signal 994. Alternatively, where count value 984 is greater than upper threshold 990 and contact indicator 992 is asserted, contact classification circuit 986 asserts a full contact signal 998. Where, on the other hand, count value 984 is greater than or equal to lower threshold, less than or equal to upper threshold 990, and contact indicator 992 is asserted, contact classification circuit 986 asserts an intermittent contact signal 996. Where contact indicator 992 is not asserted, none of slight contact signal 994, intermittent contact signal 996, nor full contact signal 998 is asserted.

It should be noted that head contact characterization circuit 960 is shown as capable of distinguishing between three distinct levels of contact: full contact, intermittent contact, and slight contact. Other embodiments of the present invention may be designed to distinguish between fewer or more distinct levels. For example, another embodiment of the present invention may only distinguish between two distinct levels of contact: full contact and slight contact. In such an embodiment, anything that would have been considered intermittent contact in the three level example, may be considered slight contact. As another example, an upper portion of anything that would have been considered intermittent contact in the three level example may be considered full contact, and a lower portion may be considered slight contact.

Turning to FIG. 3d, an example timing diagram 999 shows a process of head contact characterization in accordance with one or more embodiments of the present invention. Timing diagram 999 shows a number of instances of X data input 965 that are down sampled to a reduced number of instances of down sampled data 972. Segments of down sampled data 972 are formed by averaging a number of instances of down sampled data 972 to yield segmented data 976. Each segment of segmented data 976 is assigned a tripartite value to yield tripartite data 990. The zero crossings of tripartite data 990 are counted, and the count is used to characterize the type of contact.

Turning to FIGS. 5a-5b, flow diagrams 500, 501 show a method for contact detection and characterization in accordance with some embodiments of the present invention. Turning to FIG. 5a, and following flow diagram 500, a distance between a read/write head assembly and a storage medium is increased to an extent that no contact between the two will occur (block 505). This results in a situation where the signal received from a head disk interface is zero or small. Such data is referred to as training data as its constant nature lends itself for training parameters. A mean (μ) and variance (σ²) of the signal from the head disk interface is calculated using the training data (block 510). In particular, the mean and variance are calculated in accordance with the following equations:

$$μ = \frac{1}{N} {\sum }_{i = 1}^{N} HDI Signal ( i ) , \\ and$$

$${σ}^{2} = \frac{1}{N} {\sum }_{i = 1}^{N} {( HDI Signal ( i ) )}^{2} - {μ}^{2} .$$

It is determined whether additional instances of the HDI signal are to be used in the training process (block 515). Where more data remains to be included (block 515), the processes of block 510 is repeated to include the additional information.

Otherwise, where no more data remains to be included (block 515), the training process is complete, and the read/write head assembly is allowed to move relative to the storage medium such that the previous no-contact condition can no longer be guaranteed (block 520). The signal from the head disk interface during this period is referred to as test data. A user performance input is received (block 525). The user performance input is a threshold of false detection that may be programmed by the user. A threshold value is computed based upon the received user performance input (block 530). The threshold value is calculated based upon a performance value that is calculated in accordance with the following equation:

f(P_{f})=h\sqrt{2p}(1+0.5mp)Φ⁻¹(Pf)+[1+hp[h−1−0.5(2−h)]mp],

where:

$$h = 1 - \frac{2}{3} \frac{( M + λ ) ( M + 2 λ )}{{( M + 2 λ )}^{2}} , \\ p = \frac{( M + 2 λ )}{{( M + λ )}^{2}} , \\ and$$

$$m = ( h - 1 ) ( 1 - 3 h ) .$$

M is the number of values used in calculating the variance and the mean. From this, the threshold value is calculated in accordance with the following equation:

$$Threshold Value = \sqrt[h]{f ( {P}_{f} )} ( M + λ ) .$$

The energy of the test data is calculated (block 535). In particular, the energy is calculated in accordance with the following equation:

$$Energy = {\sum }_{i = 1}^{M} {( HDI Signal ( i ) )}^{2} .$$

The energy value is then compared with the previously calculated threshold value (block 540). Where the energy of the test data is greater than or equal to the threshold value (block 545), a contact indicator is asserted to indicate contact between the read/write head assembly and the storage medium (block 550).

Turning to FIG. 5a, and following flow diagram 501, the HDI signal is received (block 506), and is down sampled to yield a down sampled output (block 511). Where the sampling rate at which HDI signal is sampled is substantially greater than the vibration frequency of a head caused by contact, the HDI signal can be down sampled to improve the processing efficiency without degrading classification performance. The amount of down sampling applied may be chosen based upon a combination of the sampling frequency of the HDI signal and the frequency of data represented by X data input 965 (e.g., the frequency of head vibration due to contact).

An instance of the down sampled output is selected for processing (block 513). It is determined whether the instance is the first sample in a segment (block 516). An instance is the first in a segment where the preceding sample was the last element in a prior segment or for the first instance processed. Where the instance is the first sample in a segment (block 516) a current segment value is set equal to the current instance of the down sampled output (block 521). Alternatively, where the instance is not the first in a segment (block 516), the value of the current instance is averaged with the current segment value to yield an updated current segment value (block 526). It is then determined whether the instance is the last sample in a segment (block 531). The last sample in a segment is determined by counting the total number of instances incorporated in the current segment, and comparing the count value with the number of instances to be included. Where the current instance is not the last instance in a segment (block 531), the processes of blocks 516-531 are repeated for the next instance. Otherwise, where the current instance is the last in the segment (block 531), the completed segment is provided as part of a segmented data output (bloc 536). It is determined whether another instance of the down sampled data remains to be processed (block 541). Where another instance remains to be processed (block 541) the processes of blocks 516-541 are repeated for the next instances.

Otherwise, where no additional instances of the down sampled data remain to be processed (block 541), a tripartite grouping is applied to each of the completed segments of the segmented data (block 546). This tripartite grouping includes assigning one of three distinct values to each segment value of segmented data. In particular, where the value of a given segment is greater than a threshold A, then a positive value is assigned to the segment. Where, on the other hand, the value of a given segment is less than a threshold B, then a negative value is assigned to the segment. In all other cases, a zero value is assigned to the segment. In one particular case, threshold B is a negative of threshold A. In various cases, one or both of threshold A and threshold B are user programmable. The following pseudocode describes the aforementioned tripartite grouping process.

```
For Each Segment of Segmented Data {
  Select Segment of Segmented Data;
  If (Value of Selected Segment is > A) {
    Set Tripartite Value Equal to +1
  }
  Else If (Value of Selected Segment is < −A) {
    Set Tripartite Value Equal to −1
  }
  Else {
    Set Tripartite Value Equal to 0
  }
}
```

It is determined whether a contact is indicated (block 551). A contact is indicated where a contact indicator is asserted in block 550 of FIG. 5a. Where a contact is not indicated (block 551), no additional processing is performed and no contact characterization is made. Otherwise, where a contact is indicated (block 551), a number of zero crossings of the tripartite data is counted (block 556). In particular, the number of times tripartite data transitions from a positive value to a negative value, and from a negative value to a positive value (i.e., each time it crosses the zero point) is counted. End points are also accounted for by incrementing the count when the count period begins with a zero and subsequently is changed to a positive value or a negative value, and when the count period ends with a zero value from either a positive value or a negative value that occurred within the count period. This process of counting zero crossings is continued over a count period which is a window of time over which zero crossings are monitored. At the end of the count period, the count is compared against threshold values. In particular, it is determined whether the resulting count is greater than a lower threshold (block 561). Where the count is not greater than the lower threshold (block 561), a slight contact output is asserted (block 581).

Otherwise, the count is greater than the lower threshold (block 561), it is determined whether the resulting count is greater than an upper threshold (block 566). Where the count is greater than the upper threshold (block 566), a full contact output is asserted (block 571). Otherwise, where the count is not greater than the upper threshold (block 566), an intermittent contact output is asserted (block 576).

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, the invention provides novel systems, devices, methods and arrangements for data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A storage device, the storage device comprising:
a storage medium;
a read/write head assembly disposed in relation to the storage medium, wherein the read/write head assembly includes a sensor operable to provide a sensor output indicating contact between the read/write head assembly and the storage medium;
a touch down detection circuit operable to indicate a contact between the read/write head assembly and the storage medium; and
a head contact characterization circuit operable to determine a level of contact between the read/write head assembly and the storage medium, wherein the level of contact is selected between at least a first contact level and a second contact level.

2. The storage device of claim 1, wherein the first contact level is a full contact, and wherein the second contact level is selected from a group consisting of a slight contact and an intermittent contact.

3. The storage device of claim 1, wherein the level of contact is selected between at least a first contact level, a second contact level, and a third contact level; and wherein the first contact level is a full contact, the second contact level is an intermittent contact, and the third contact level is a slight contact.

4. The storage device of claim 1, wherein the head contact characterization circuit is further operable to provide a contact level output indicating the level of contact only if the touch down detection circuit indicates the contact between the read/write head assembly and the storage medium.

5. The storage device of claim 1, wherein the contact characterization circuit comprises:
a signal processing circuit operable to generate a contact indicative signal from the sensor output;
a crossing counter operable to count a number of times the contact indicative signal crosses a threshold value to yield a count value; and
a contact classification circuit operable to select the level of contact between the read/write head assembly and the storage medium based at least in part on the count value.

6. The storage device of claim 5, wherein the contact classification circuit includes a comparator circuit operable to compare the count value with a level threshold value to distinguish between the first contact level and the second contact level.

7. The storage device of claim 6, wherein the level threshold is user programmable.

8. The storage device of claim 5, wherein the threshold value is zero.

9. The storage device of claim 5, wherein the level of contact is selected between at least a first contact level, a second contact level, and a third contact level; wherein the first contact level is a full contact, the second contact level is an intermittent contact, and the third contact level is a slight contact; and wherein the contact classification circuit includes a first comparator circuit operable to compare the count value with a first level threshold value and a second comparator circuit operable to compare the count value with a second level threshold value to distinguish between the first contact level, the second contact level, and the third contact level.

10. The storage device of claim 5, wherein the signal processing circuit comprises a signal averaging circuit operable to average multiple instances to yield a series of average instances, and a tripartite grouping circuit operable to assign one of three values to each of element of the series of instances to yield the contact indicative signal.

11. The storage device of claim 1, wherein the storage device is a hard disk drive.

12. The storage device of claim 1, wherein the touch down detection circuit is an energy based touch down detection circuit.

13. A method for contact classification, the method comprising:
receiving a head contact indication;
receiving a sensor output;
processing the sensor input to determine a number of threshold crossings using a crossing counter circuit; and
selecting a contact level from at least a first contact level and a second contact level based at least in part on a combination of the head contact indication and the number of threshold crossings.

14. The method of claim 13, wherein the first contact level is a full contact, and wherein the second contact level is selected from a group consisting of a slight contact and an intermittent contact.

15. The method of claim 13, wherein the level of contact is selected between at least a first contact level, a second contact level, and a third contact level; and wherein the first contact level is a full contact, the second contact level is an intermittent contact, and the third contact level is a slight contact.

16. The method of claim 13, wherein processing the sensor input comprises:
processing the sensor signal to generate a contact indicative signal from the sensor output;
counting a number of times the contact indicative signal crosses a threshold value to yield the number of threshold crossings.

17. The method of claim 16, wherein the threshold value is zero.

18. The method of claim 13, wherein selecting the contact level includes comparing the number of threshold crossings with a level threshold level to distinguish between the first contact level and the second contact level.

19. The method of claim 18, wherein the level threshold is user programmable.

20. A contact level distinguishing circuit, the circuit comprising:
a head contact characterization circuit operable to:
receive a sensor output indicating contact between a read/write head assembly and a storage medium; and
determining a level of contact between the read/write head assembly and the storage medium based at least in part on the sensor output, wherein the level of contact is selected between at least a first contact level, a second contact level, and a third contact level.
